(19) United States
(12) Patent Application Publication
(10) Pub. No.: US 2014/0210746 A1
(43) Pub. Date: Jul. 31, 2014

(54) DISPLAY DEVICE AND METHOD FOR ADJUSTING DISPLAY ORIENTATION USING THE SAME

(71) Applicant: Seung II KIM, Seoul (KR)

(72) Inventors: Seung Il KIM, Seoul (KR); Jae Chan LEE, Seoul (KR)

(73) Assignee: Seung II KIM, Seoul (KR)

(21) Appl. No.: 14/164,267

(22) Filed: Jan. 27, 2014

Related U.S. Application Data
(60) Provisional application No. 61/756,468, filed on Jan. 25, 2013.

(51) Int. Cl. G06F 3/041

(52) U.S. Cl. CPC G06F 3/041
USPC 345/173

(57) ABSTRACT

The present invention relates generally to a display device and method for adjusting display orientation using the same, and more particularly, to a display device and method for adjusting display orientation of a displayed object based on user position. According to one aspect of the present invention, a display device may be provided, comprising: a display; a touch sensitive module detecting touches on the display; and a controller configured to: display, via the display, at least one object, receive, via the touch sensitive module, a multi-touch on a specific object among the at least one object, determine a user position based on positional relationship among touch points of the multi-touch, and adjust display orientation of the specific object based on the user position.

### CROSS REFERENCE TO RELATED APPLICATIONS

This application claims priority benefits under 35 U.S. C. §119(e) from U.S. Provisional Application No. 61/756,468, filed on Jan. 25, 2013 and entitled “Display device and method for adjusting display orientation using the same”, which is hereby incorporated by reference as if fully set forth herein.

### BACKGROUND OF THE INVENTION

1. Field of the Invention

The present invention relates generally to a display device and method for adjusting display orientation using the same, and more particularly, to a display device and method for adjusting display orientation of a displayed object based on user position.

2. Discussion of the Related Art

Ubiquitous environment aims to provide intelligent services connecting the whole environment of life organically. As a table is a space used most frequently in real life, including at home or at office, a table-top interface implemented on a table may be one of core components in building ubiquitous environment.

The unique feature of a table-top interface is a multi-user interface that is used by several users simultaneously, which is different from existing personalized computing environments. Specifically, with a table-top interface, each user may interact and cooperate with each other as placing physical object(s) on a table or touching a table.

As it is common with a table-top interface that several persons perform operations simultaneously, it requires UX (user experience) providing contents in a way suitable to a multi-user interface.

### SUMMARY OF THE INVENTION

Accordingly, the present invention is directed to a display device and method for adjusting display orientation using the same that substantially obviates one or more problems due to limitations and disadvantages of the related art.

It is, therefore, an object of the present invention to provide a table-top display device with a table-top interface providing displayed contents in a normal direction to a corresponding user who uses the contents and method for controlling the same.

To achieve these and other advantages and in accordance with the purpose of the invention, as embodied and broadly described herein, in an aspect of an embodiment of the present invention, there is provided a display device comprising: a display; a touch sensitive module detecting touches on the display; and a controller configured to: display, via the display, at least one object, receive, via the touch sensitive module, a multi-touch on a specific object among the at least one object, determine a user position based on positional relationship among touch points of the multi-touch, and adjust display orientation of the specific object based on the user position.

In another aspect of an embodiment of the present invention, there is provided an electronic device comprising: a display; a touch sensitive module detecting touches on the display; and a controller configure to: display, via the display, at least one object, receive, via the touch sensitive module, a multi-touch on a specific object among the at least one object, and adjust display orientation of the specific object based on positional relationship among at least three touch points of the multi-touch.

In still another aspect of an embodiment of the present invention, there is provided a method for adjusting display orientation comprising: displaying at least one object; receiving a multi-touch on a specific object among the at least one object; determining a user position based on positional relationship among touch points of the multi-touch; and adjusting the display orientation of the specific object based on the user position.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a skew view of a table-top display device according to one embodiment of the present invention.

FIG. 2 is a block diagram illustrating a table-top display device according to another embodiment of the present invention.

FIG. 3 is a flow chart illustrating a method of adjusting display orientation according to still another embodiment of the present invention.

FIG. 4 illustrates one embodiment of a screen displaying at least one object in the method for adjusting display orientation of FIG. 3.

FIG. 5 illustrates one embodiment of detecting a multi-touch on a specific object in the method for adjusting display orientation of FIG. 3.

FIG. 6 illustrates one embodiment of determining user position in the method for adjusting display orientation of FIG. 3.

FIG. 7 illustrates one embodiment of receiving signals of a multi-touch in the method for adjusting display orientation of FIG. 3.

FIG. 8 is an enlarged view of B section in FIG. 7.

FIGS. 9 and 10 illustrate one embodiment of calculating user position based on a multi-touch in the method for adjusting display orientation of FIG. 3.

FIGS. 11 to 14 illustrate one embodiment of adjusting display orientation of a specific object in the method for adjusting display orientation of FIG. 3.

FIG. 15 illustrates another embodiment of adjusting display orientation of a specific object in the method for adjusting display orientation in FIG. 3.

FIGS. 16 and 17 illustrate still another embodiment of adjusting display orientation of a specific object in the method for adjusting display orientation in FIG. 3.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Embodiments expressed in this description aims to describe clearly concepts of the present invention to any person having ordinary skill in the art to which the present invention pertains, and the present invention is not limited to embodiments in this description, and the scope of the present invention should be understood to include modifications or variations without departing from the spirit of the present invention.

As terms used in the present description and drawings accompanied to the same aim to make it easy to describe the present invention, and images depicted in drawings are exaggerated, if necessary, to help the understanding of the present invention, the present invention is not limited to terms used in the present description and drawings accompanied to the same.

If it is determined that any detailed description on known configurations or functions of the present invention may obscure the gist of the present invention in the present description, detailed description thereof will be omitted, if necessary.

According to one aspect of the present invention, a display device may be provided, comprising: a display; a touch sensitive module detecting touches on the display; and a controller configured to: display, via the display, at least one object, receive, via the touch sensitive module, a multi-touch on a specific object among the at least one object, determine a user position based on positional relationship among touch points of the multi-touch, and adjust display orientation of the specific object based on the user position.

Herein, the controller may adjust the display orientation by setting a direction from a upper side to a lower side of the specific object toward the user position.

Herein, the user position may be a specific side on which a user is positioned among sides of the display, and the controller may adjust the display orientation by setting a direction from a upper side to a lower side of the specific object toward the specific side.

Herein, the direction may be perpendicular to the specific side and the lower side may be closer to the specific side than the upper side.

Herein, the upper side and the lower side of the specific object may be parallel to the specific side.

Herein, the touch points of the multi-touch may include first touch points and at least one second touch point, the first touch points including two farthest touch points among the touch points, and the specific side may be farther from the at least one second touch point than each of the first touch points.

Herein, the touch points of the multi-touch may include first touch points and at least one second touch point, the first touch points including two farthest touch points among the touch points, and the specific side may be opposite to the at least one second touch point based on a line connecting the first touch points.

Herein, the touch points of the multi-touch may include first touch points and at least one second touch point, the first touch points including two farthest touch points among the touch points, and wherein the controller may determine the user position based on a direction from the at least one second touch point to a line connecting the first touch points.

According to another aspect of the present invention, an electronic device may be provided, comprising: a display; a touch sensitive module detecting touches on the display; and a controller configure to: display, via the display, at least one object, receive , via the touch sensitive module, a multi-touch on a specific object among the at least one object, and adjust display orientation of the specific object based on positional relationship among at least three touch points of the multi-touch.

Herein, a controller may determine a specific side on which a user is positioned among sides of the display based on the positional relationship, and may adjust the display orientation in a normal direction to the specific side.

Herein, the normal direction to the specific side may be a direction from a upper side to a lower side of the specific object may be toward the specific side.

Herein, the at least three touch points may include first touch points and at least one second touch point, the first touch points including two farthest touch points among the at least three touch points, and the controller may adjust the display orientation so that a direction from a upper side to a lower side of the specific object is toward a specific side of the display, the specific side being farther from the at least one second touch point than each of the first touch points.

Herein, the at least three touch points may include first touch points and at least one second touch points, the first touch points including two farthest touch points among the at least three touch points, and the display orientation of a specific object may be adjusted so that the direction from a upper side to a lower side of the specific object is toward a specific side of the display, the specific side being opposite to the at least one second touch point based on a line connecting the first touch points.

According to still another aspect of the present invention, a method for adjusting display orientation may be provided, comprising: displaying at least one object; receiving a multi-touch on a specific object among the at least one object; determining a user position based on positional relationship among touch points of the multi-touch; and adjusting the display orientation of the specific object based on the user position.

Herein, the adjusting the display orientation may include setting a direction from a upper side to a lower side of the specific object toward the user position.

Herein, the user position may be a specific side on which a user is positioned among sides of the display, and the adjusting the display orientation may include setting the direction from a upper side to a lower side of the specific object toward the specific side.

Herein, the touch points of the multi-touch may include first touch points and at least one second touch point, the first touch points including two farthest touch points among the touch points, wherein the specific side may be farther from the at least one second touch point than each of the first touch points.

Herein, the touch points of the multi-touch may include first touch points and at least one second touch point, the first touch points including two farthest touch points among the touch points, the specific side may be opposite to the at least one second touch point based on a line connecting the first touch points.

Herein, the touch points of the multi-touch may include first touch points and at least one second touch point, the first touch points including two farthest touch points among the touch points, the user position may be determined based on a direction from the at least one second touch point to a line connecting the first touch points.

Hereinafter, a table-top display device 1000 is described according to one embodiment of the present invention.

According to one embodiment of the present invention, a table-top display device 1000 is a device providing collaboration space A used by several users altogether.

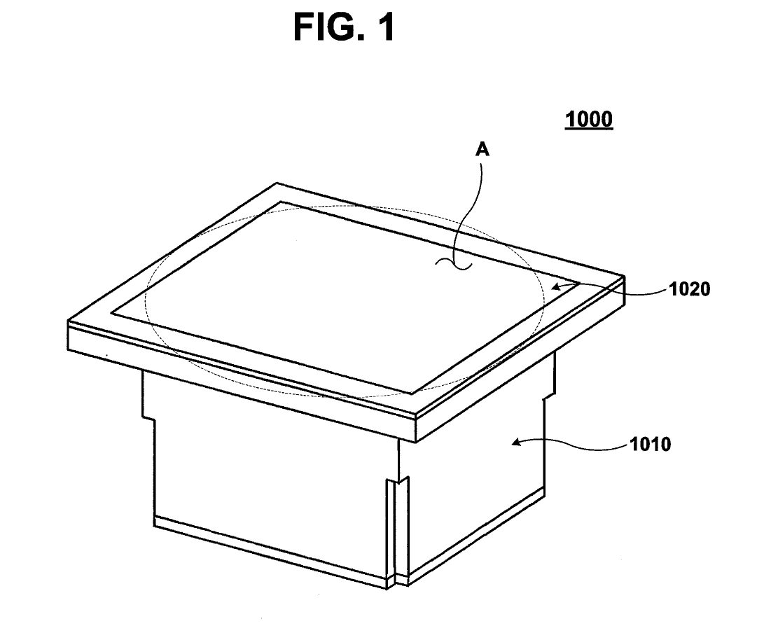

FIG. 1 is a skew view of a table-top display device according to one embodiment of the present invention.

According to one embodiment, a table-top display device 1000 may be provided in a table-top form where a display panel 1020 is placed on the table frame 1010 to provide a collaboration space A.

A table-top display device 1000 may display various contents on collaboration space A provided by display panel 1020. Also, a table-top display device 1000 may provide virtual objects corresponding to physical objects placed on collaboration space A implemented on top of the table as augmented reality, or display them on a display panel 1020. Therefore, users may perform any operation by touching collaboration space A or managing physical objects on the space A.

On the other hand, FIG. 1 shows a table-top display device 1000 in a table-top form where a rectangular display panel 1020 is placed on a table frame, but a table-top display device 1000 is not limited to the form mentioned above. For example, a table-top display device 1000 may be provided in a flat panel form, rather than in a table-top form, and the display panel 1020 may be in various forms, including rectangle, polygon, circle, or ellipse.

Hereinafter, the configuration of a table-top display device 1000 is described based on another embodiment of the present invention.

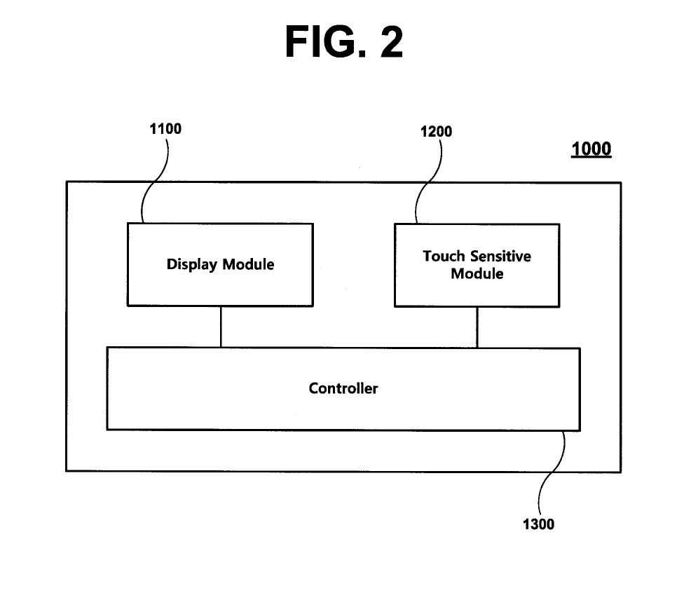

FIG. 2 is a block diagram illustrating a table-top display device according to another embodiment of the present invention.

According to FIG. 2, a table-top display device 1000 may contain a display module 1100, a touch sensitive module 1200, and a controller 1300.

A display module 1100 may display images. A display module 1100 may display various contents. Contents may include documents, pictures, videos, internet pages, icons, or applications. In addition, a display module 1100 may display background images or graphic user interfaces.

A display module 1100 may be provided in a form of a display panel 1020. A display panel 1020 may be FPD (Flat Panel Display) in various forms, including LCD (Liquid Crystal Display) or OLED (Organic Light Emitting Diode) displays.

A touch sensitive module 1200 may detect touches on a display panel 1020. In other words, touch sensitive module may generate electric signals based on variations of pressure or capacitance caused by any touch on a specific section of a display panel 1020. A controller 1300 may detect any touch, position and size of touch point, touch force, or touch pressure based on the electric signals. For example, a touch sensitive module 1200 generates electric signals corresponding to touch points on a display panel 1020 for any touch, and a controller 1300 calculates coordinates of touch points based on the electrical signals.

The touch sensors may be integrated into a display panel 1020 to form a touch screen. For example, a touch sensitive module 1200 may be implemented in various forms, including touch film, touch sheet, or touch pad, which are attached to a display panel. In addition, touch films, touch sheets, or touch pads may be implemented in a form of touch sensors, including capacitive touch sensors, resistive touch sensors, or optical touch sensors.

Or, it is also possible to implement a touch sensitive module 1200 as a camera system recognizing user's gestures with an image recognition technique. A camera system may capture images through a 3D camera, including a standard camera or a depth camera, and may detect touches by recognizing touch gesture on a display panel 1020.

A controller 1300 may control overall functions of a table-top display device 1000. A controller 1300 may process various kinds of information, or may control other components of a table-top display device 1000. For example, a controller 1300 may control a display module 1100 to display images, or may detect any touch through a touch sensitive module 1200, which is described above.

A controller 1300 may be implemented as a computer or any device similar to the same by utilizing hardwares, softwares or combinations of them. The hardware section of a controller 1300 may be provided in a form of electronic circuits performing control functions by processing electrical signals, and the software section of a controller may be provided in a form of a program running the hardware section 1300. Representatives of electronic circuits include ASICs (application specific integrated circuits), DSPs (digital signal processors), DSPDs (digital signal processing devices), PLDs (programmable logic devices), FPGAs (field programmable gate arrays), and micro-processors. The software section of a controller 1300 may be implemented as a software application written in software codes by using appropriate programming languages.

Therefore, a controller 1300 may execute procedures, functions or every embodiment described in the present description.

Hereinafter, a method for adjusting display orientation is described according to still another embodiment of the present invention.

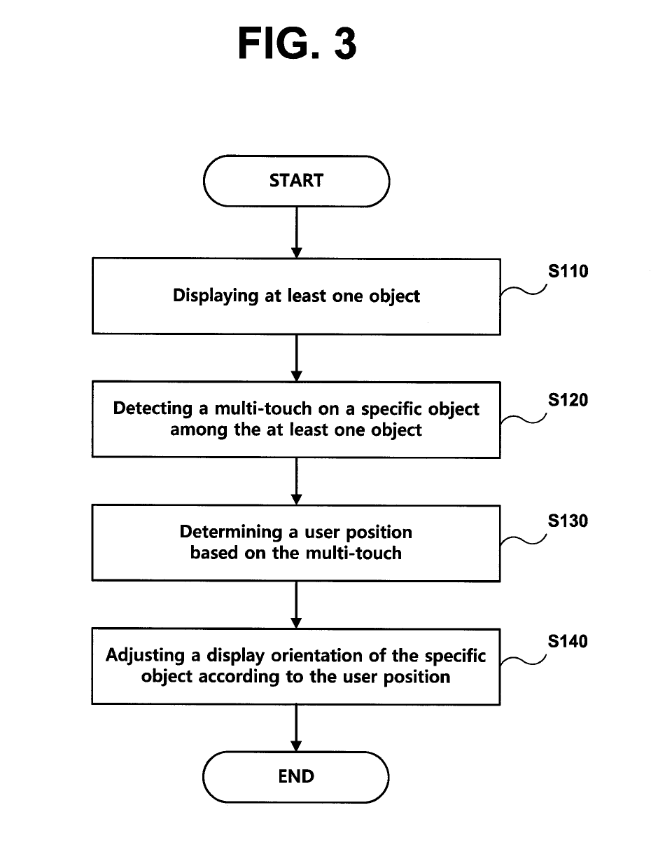

FIG. 3 is a flow chart illustrating a method of adjusting display orientation according to still another embodiment of the present invention.

According to FIG. 3, a method for adjusting display orientation may comprise stages of displaying at least one object (S110), detecting a multi-touch on a specific object among the at least one object (S120), determining user position based on received signals of a multi-touch (S130), and adjusting display orientation of a touched specific object based on the user position (S140).

Hereinafter, each of the stages is described in detail.

A table-top display device 1000 may display at least one object (S110).

A controller 1300 may display at least one object through a display module 1100. An object may be contents described above or a window frame containing the same contents.

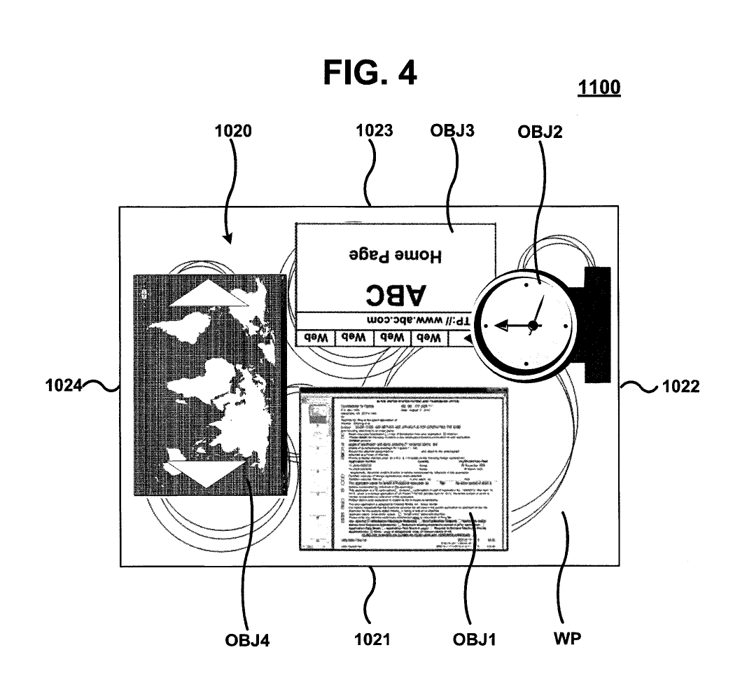

FIG. 4 illustrates one embodiment of a screen displaying at least one object in the method for adjusting display orientation of FIG. 3.

According to FIG. 4, a display module 1100 may be provided as a rectangular display panel 1020 with the first side 1021, the second side 1022, the third side 1023, and the fourth side 1024.

According to one embodiment, a display panel 1020 may display background (WP), which is shown in FIG. 4, and may display the first object (OBJ1), the second object (OBJ2), the third object (OBJ3), and the fourth object (OBJ4) on the background.

The first object (OBJ1) may be a document object. The first object (OBJ1) is displayed in a normal direction to the first side 1021. In other words, the display orientation of the first object (OBJ1) is in a normal direction to the first side 1021.

Here, a display orientation means the orientation that an object is displayed on a display panel 1020. A normal direction of a specific object means that the direction from the upper side to the lower side of the specific object points to a specific position. For example, if a display orientation of the first object (OBJ1) is in a normal direction to the first side 1021, the first object (OBJ1) may be positioned so that the upper side or line of the first object is far from the first side 1021 and the lower side or line of the first object is close to the first side 1021.

The second object (OBJ1) may be a watch application. The second object (OBJ2) is displayed in a normal direction to the second side 1022. The third object (OBJ3) may be an internet page. The third object (OBJ3) is displayed in a normal direction to the third side 1023. The fourth object (OBJ4) is a picture. The fourth object (OBJ4) is displayed in a normal direction to the fourth side 1024.

While the first object (OBJ1), the second object (OBJ2), and the third object (OBJ3) may have a window frame, respectively, the fourth object (OBJ4) may be displayed only with its contents and no window frame.

A table-top display device 1000 may detect a multi-touch on a specific object among at least one object displayed (S120).

A touch sensitive module 1200 generates electrical signals based on received signals of touches on a display panel 1020, and a controller 1300 may detect the touch when receiving the electrical signal. In this case, a controller 1300 may recognize any multi-touch when multiple touch points are detected. In addition, a controller 1300 may calculate coordinates of each touch points based on electrical signals. A controller 1300 may determine any multi-touch on a specific object when touch points are within the displayed region of a specific object among displayed objects based on calculated coordinates.

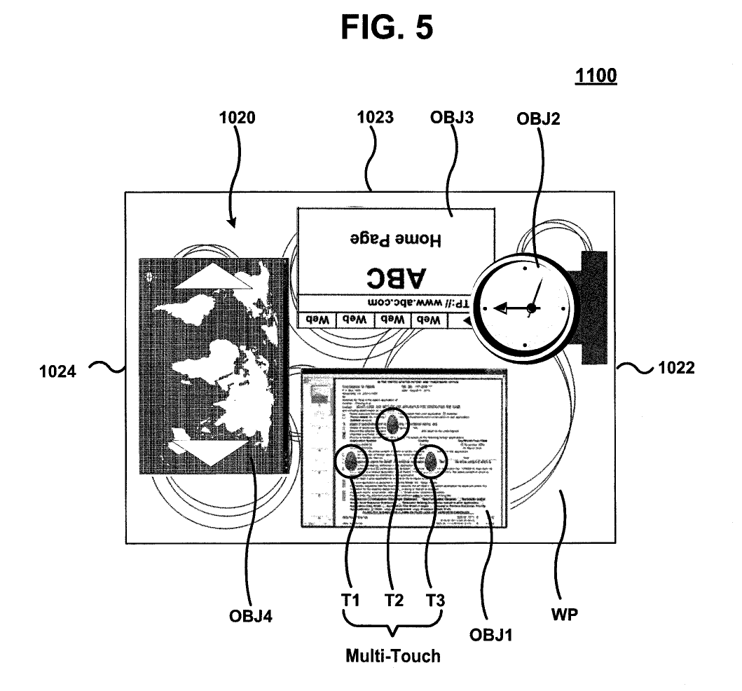

FIG. 5 illustrates one embodiment of detecting a multi-touch on a specific object in the method for adjusting display orientation of FIG. 3.

According to one embodiment, one display panel 1020 may receive signals of a multi-touch with three touch points, that is, the first touch point (T1), the second touch point (T2), and the third touch point (T3), as shown in FIG. 5. A controller 1300 may calculate coordinates of touch points through a touch sensitive module 1200. All the touch points (T1, T2, and T3) are determined to be within the display region of the first object (OBJ1) based on coordinates of each touch point, as shown in FIG. 5. Therefore, a controller 1300 may determine that the detected multi-touch is touches on the first object (OBJ1).

In the above, it is described that only a multi-touch with all touch points in the display region of a specific object may be recognized as touches on the specific object. However, it is also possible for a multi-touch to be recognized as any touch on a specific object even when at least one touch point of the multi-touch is within display region of the specific object. Specifically, when signals of three touches on the object are received but signals of a remaining touch except two touches in far position to each other is within display area of the object, or at least two of three touches are within display area of the object, it is also possible to determine a multi-touch on an object.

It is not required that a multi-touch consists of three touch points without fail, and the number of touch points may increase or decrease, if necessary.

In addition, a controller 1300 may determine whether a multi-touch on a specific object is performed by one user. For one example, a controller 1300 obtains touch times of touches of a multi-touch from a touch sensitive module 1100 and determines whether or not a multi-touch is performed by one user based on touch time information. When touch times of each touches of a multi-touch are within in a predetermined time interval, a controller 1300 determines that a multi-touch is performed by one user. When touch times of each touches of a multi-touch are not within in a predetermined time interval, a controller 1300 determines that a multi-touch is performed by at least two users. For another example, a controller 1300 obtains touch positions of touches of a multi-touch from a touch sensitive module and determines whether or not a multi-touch is performed by one user based on touch position information. When touch positions of each touches of a multi-touch are within in a predetermined distance, a multi-touch is performed by one user. When touch positions of each touches of a multi-touch are not within in a predetermined distance, a multi-touch is not performed by at least two users. If a multi-touch on a specific object is not performed by one user, then adjusting display orientation of a specific object may not be performed. In other words, a table-top display device may adjust display orientation of a specific object only when a multi-touch on a specific object is performed by one user.

A table-top display device 1000 may determine user position based on signals of a multi-touch (S130).

A controller 1300 may determine user position based on detected signals of a multi-touch, as described above. User position means information on a relative position of a user to a display panel 1020, and may be defined to be a specific side on which a user is positioned among physical sides of a display panel 1020.

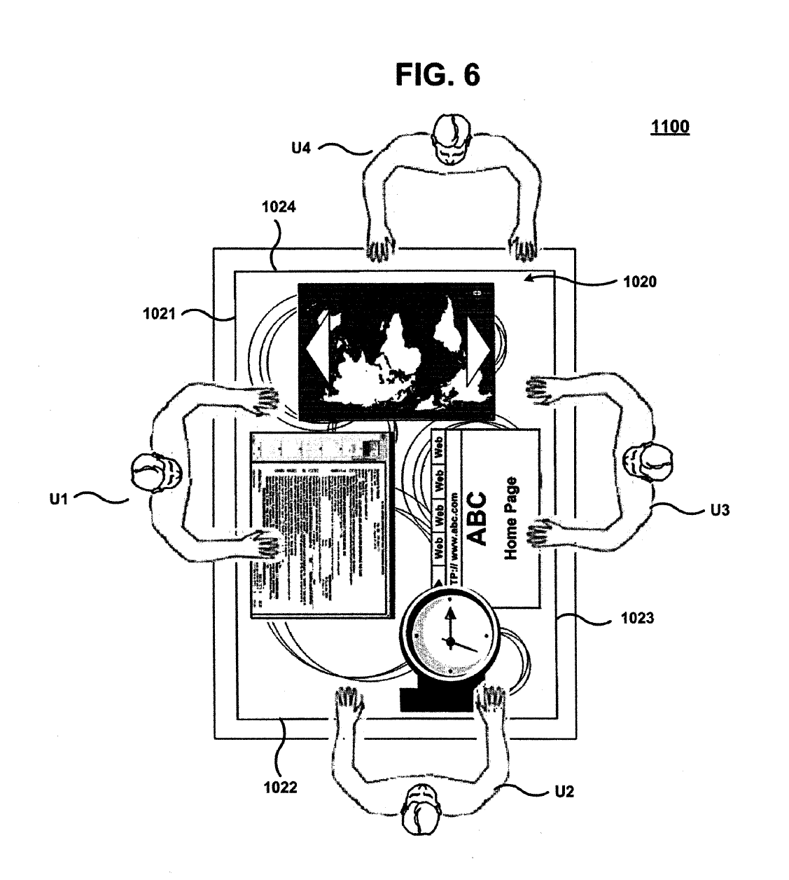

FIG. 6 illustrates one embodiment of determining user position in the method for adjusting display orientation of FIG. 3.

According to FIG. 6, there are the first user (U1), the second user (U2), and the third user (U3) around a display panel 1020. The first user (U1) is positioned on the first side 1021. The second user (U2) is positioned on the second side 1022. The third user (U2) is positioned on the third side 1023.

Therefore, the user position of the first user (U1) may be the first side 1021. The user position of the second user (U2) may be the second side 1022. The user position of the third user (U3) may be the third side 1023.

A controller 1300 may determine a user position, which is defined as a specific side on a display panel 1020, based on positional relationship among touch points of a multi-touch.

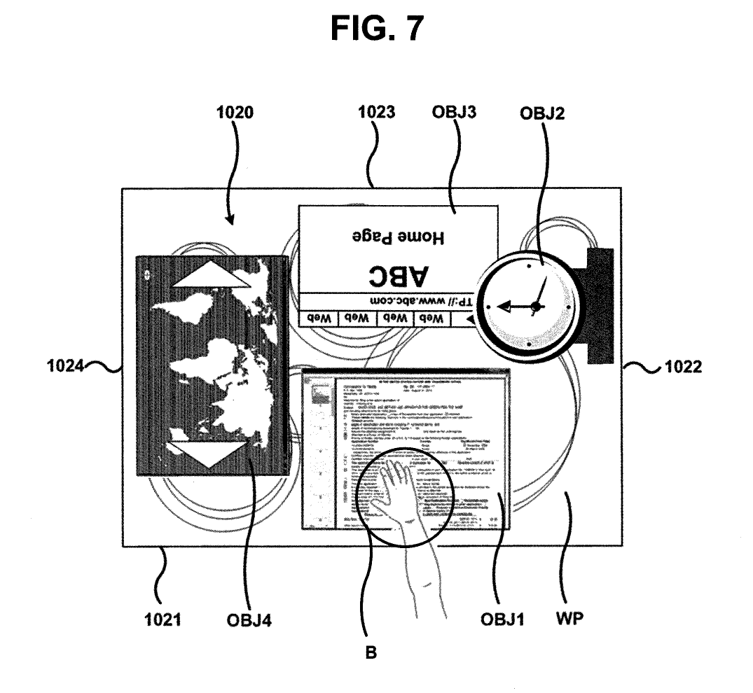

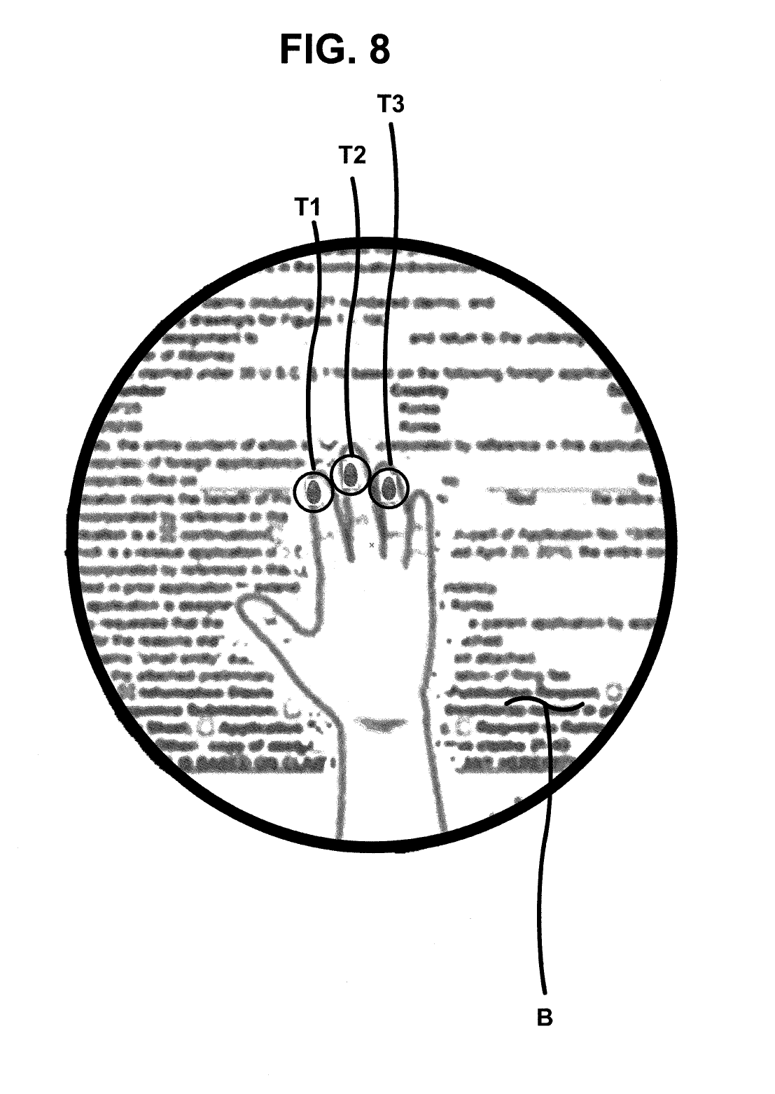

FIG. 7 illustrates one embodiment of receiving signals of a multi-touch in the method for adjusting display orientation of FIG. and, FIG. 8 is an enlarged view of B section in FIG. 7.

According to FIGS. 7 and 8, a multi-touch is being performed by three fingers on a display panel 1020. For example, the three fingers may be an index finger, a middle finger, or a ring finger. Maybe the first touch point (T1) and the third touch point (T3), which are far from each other, are touch points touched by an index finger or a ring finger, and the remaining second touch point (T2) is touched by a middle finger. Generally, a middle finger is the longest, and an index finger and a ring finger are relatively short, among fingers of a person. Therefore, if a multi-touch is performed by an index finger, a middle finger, and a ring finger, the second touch point corresponding to a middle finger is in farther position from a user than the first touch point (T1) and the third touch point (T3) are.

Based on this principle, user position may be predicted by using coordinates of each touch point of a multi-touch.

For example, a specific side on which a user is positioned may be determined to be a side with the distance to the second touch point (T2) longer than the distance to the first touch point (T1) and the distance to the third touch point (T3) among sides of a display panel 1020.

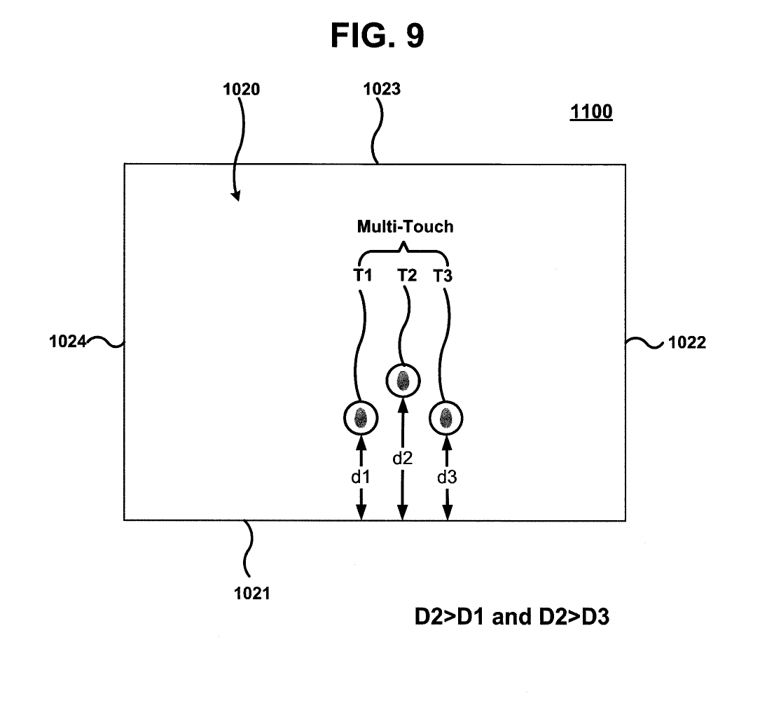

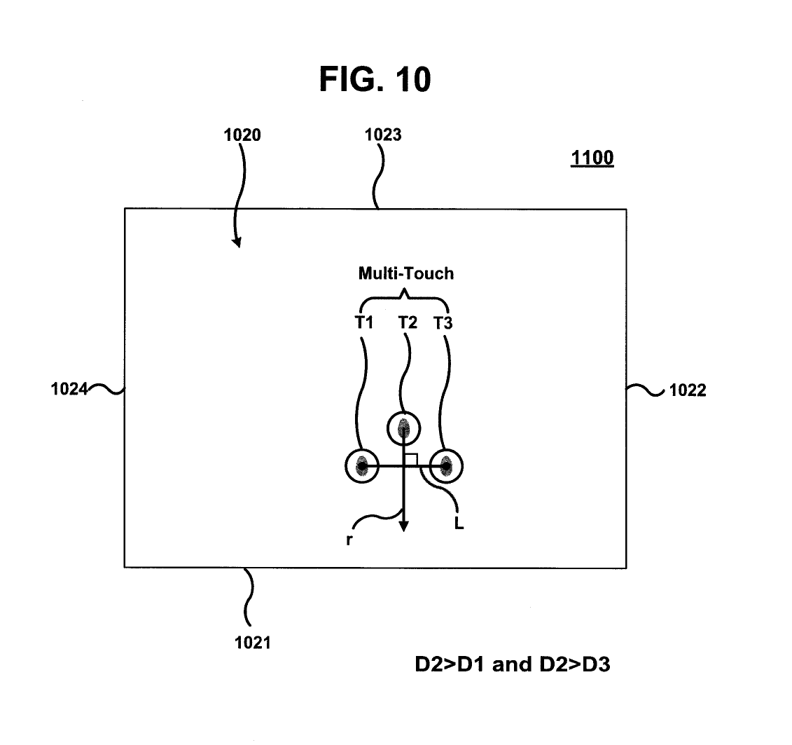

FIGS. 9 and 10 illustrate one embodiment of calculating user position based on a multi-touch in the method for adjusting display orientation of FIG. 3.

Specifically, according to FIG. 9, the first side 1021 among sides of a display panel 1020 may be determined to be a user position, as the distance between the first side 1021 and the second touch point (T2) is longer than the distance (d1) to the first touch point (T1) and the distance (d3) to the third touch point (T3).

As another example, it may be expected that a user is positioned in opposite of the second touch point (T2) based on the line connecting the first touch point (T1) and the third touch point (T3). In other words, a specific side on which a user is positioned may be determined to be the side of a display panel 1020 that meets a line, which is crossing the same line in perpendicular or in other angle specified in advance from the second touch point (T2).

Specifically, referring to FIG. 10, a line (r) from the second touch point (T2) is crossing a segment (L) connecting the first touch point (T1) and the third touch point (T3). A user position may be determined to be the first side 1021 of display panel 1020 that meets the line (r).

A table-top display device 1000 may adjust display orientation of a touched object based on user position (S140).

A controller 1300 may adjust display orientation of a touched specific object to be in a normal direction to user position.

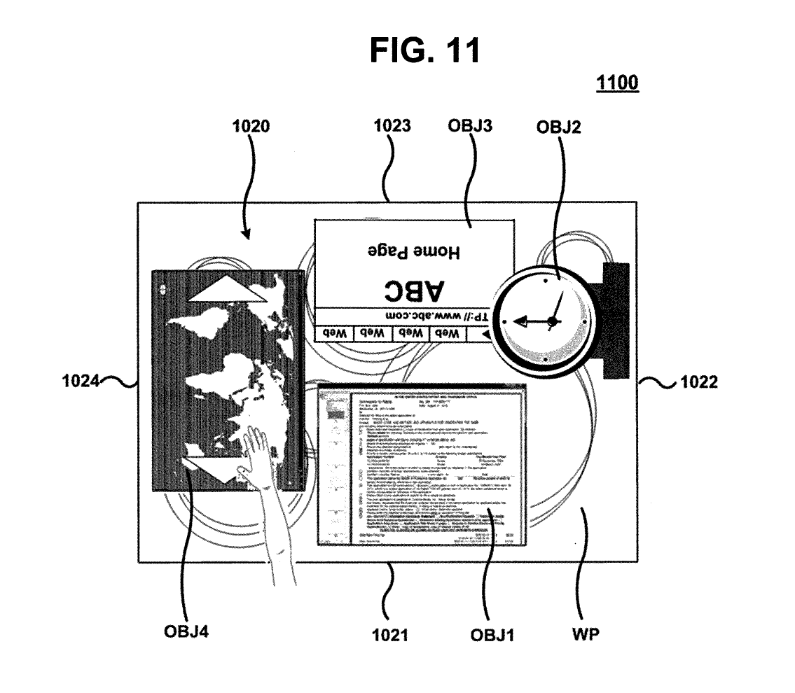

FIGS. 11 to 14 illustrate one embodiment of adjusting display orientation of a specific object in the method for adjusting display orientation of FIG. 3.

Referring to FIG. 11, a display panel 1020 may display background (WP), the first object (OBJ1), the second object (OBJ2), the third object (OBJ3), and the fourth object (OBJ4) on the background. Here, the first object (OBJ1), the second object (OBJ2), the third object (OBJ3), and the fourth object (OBJ4) are displayed in a normal direction to the first side 1021, the second side 1022, the third side 1023, and the fourth side 1024, respectively.

A user is positioned on the first side 1021, and performs a multi-touch on the fourth object (OBJ4). A controller 1300 obtains coordinates of touch points through a touch sensitive module 1200 based on received signals of a multi-touch to confirm the touch points are positioned within the display region of the fourth object (OBJ4), which is used to determine a multi-touch on the fourth object (OBJ4). Also, the controller 1300 may determine that the first side 1021 is the user side based on positional relationship among touch points.

Therefore, a controller 1300 may adjust the display orientation of the second object (OBJ4) from a normal direction to the fourth side 1024 to a normal direction to the first side 1021. Specifically, a controller 1300 may adjust display orientation of the fourth object (OBJ4) so that the upper side and the lower side of the fourth object (OBJ4) are parallel to the first side 1021, the upper side is farther from the first side 1021 than the lower side, and both sides of the fourth object (OBJ4) are perpendicular to the first side 1021.

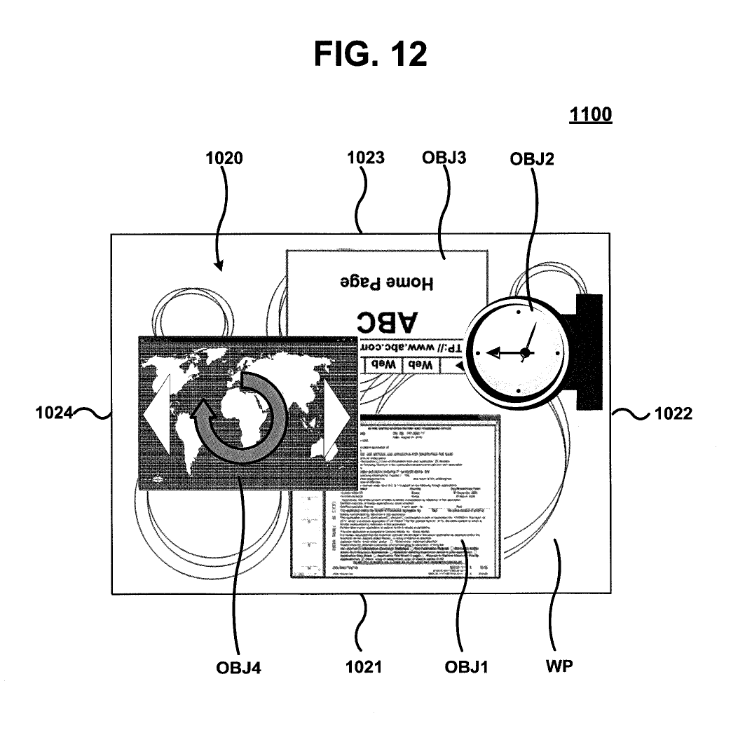

Here, it is also possible that the display orientation of the fourth object (OBJ4) is changed by rotating continuously with clockwise or counter-clockwise as shown in FIG. 12, or is changed immediately without rotation effect.

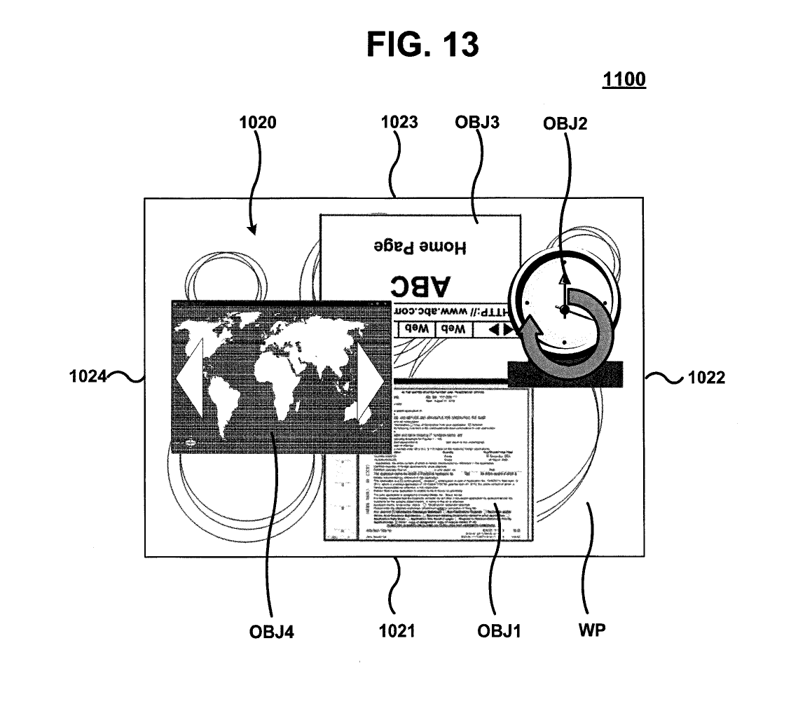

If a user performs a multi-touch on the second object (OBJ2) again, the controller 1300 may adjust display orientation in a normal direction to the first side 1021 of the second object (OBJ2), as shown in FIG. 13. Here, as the second object (OBJ2) has no rectangular window frame unlike other objects, the controller may adjust display orientation of the second object (OBJ3) so that the direction from the upper side to the lower side of the third object (OBJ3) is in perpendicular to the first side 1021.

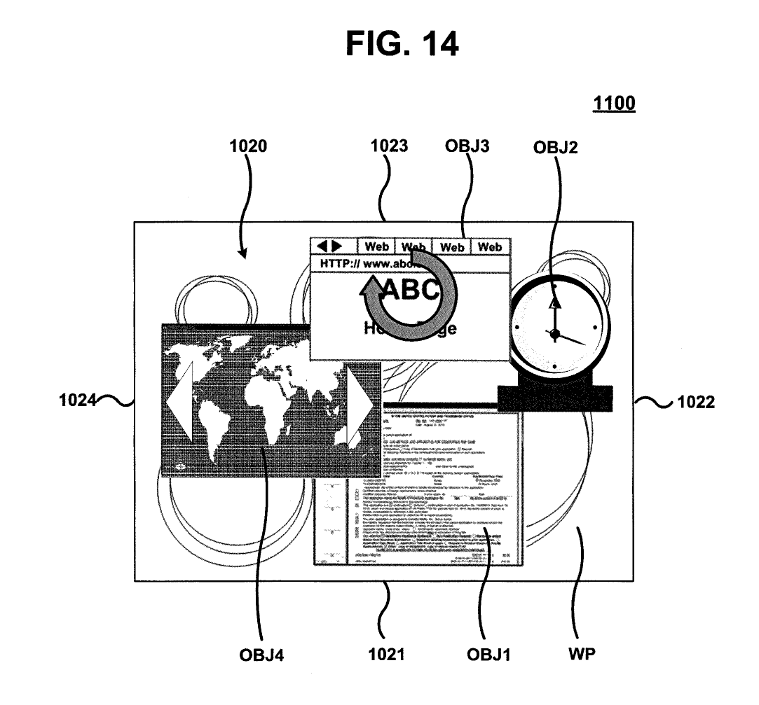

If the user performs a multi-touch on the third object (OBJ3) again, the controller 1300 may adjust display orientation in a normal direction to the first side 1021 of the third object (OBJ3), as shown in FIG. 14. Here, along with the adjustment of display orientation, the third object (OBJ3) on the lower layer of the first object (OBJ1) may be activated by the multi-touch to be placed on the upper layer of the first object (OBJ1), as shown in FIG. 13.

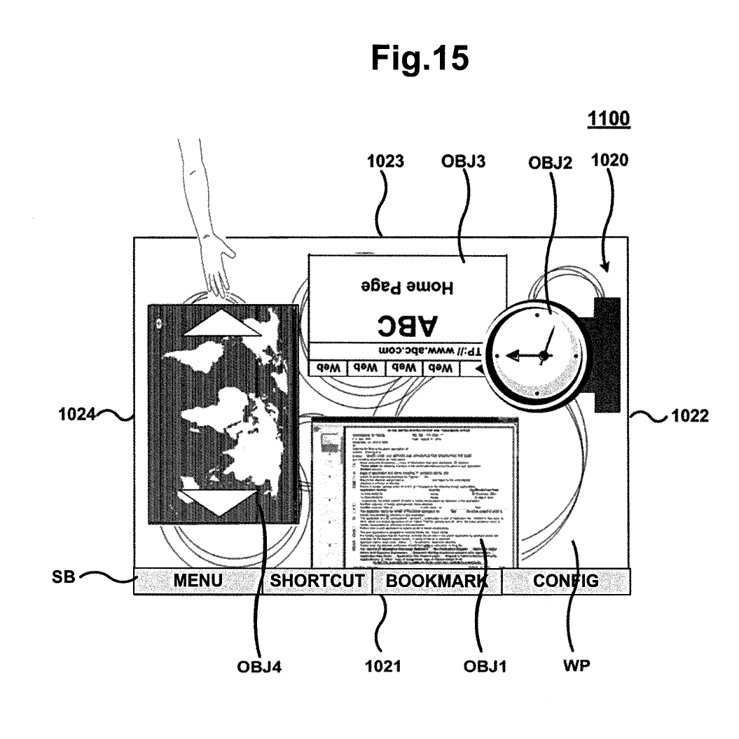

FIG. 15 illustrates another embodiment of adjusting display orientation of a specific object in the method for adjusting display orientation in FIG. 3.

Similarly to the above embodiments, if a user positioned on the third side 1023 of a display panel 1020 touches objects, each object may displayed in a normal direction to the third side 10231, as shown in FIG. 15.

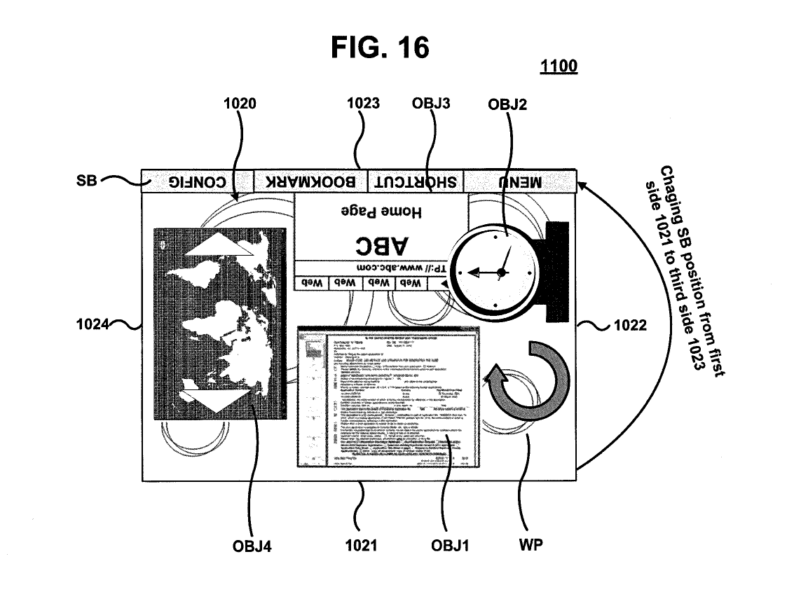

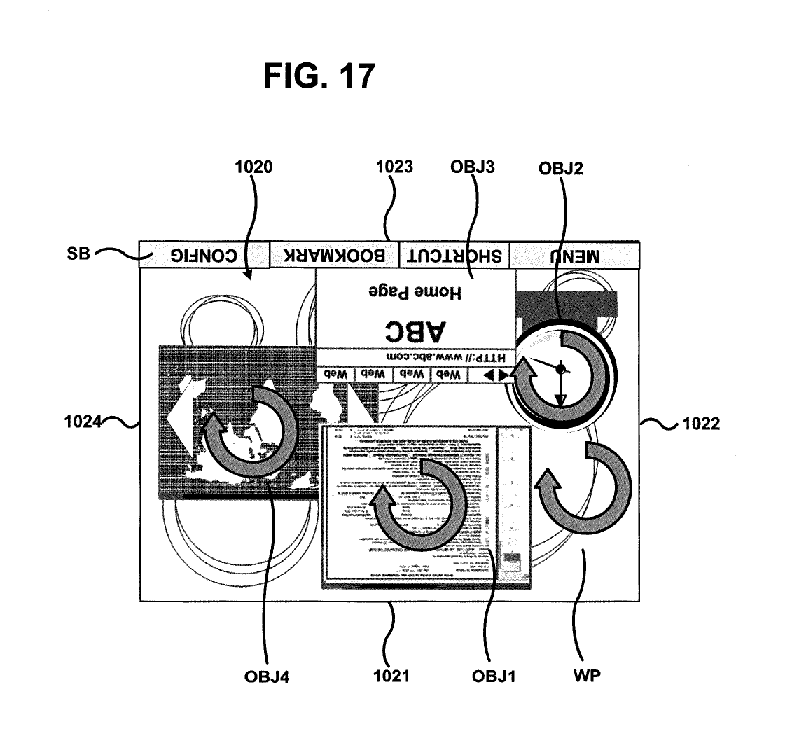

FIGS. 16 and 17 illustrate still another embodiment of adjusting display orientation of a specific object in the method for adjusting display orientation in FIG. 3.

If a user performs a multi-touch on the background (WP) in conditions of FIG. 4, display orientation of the background, which is also one object, may be adjusted into a normal direction to the third side 1023 from the first side 1021. In this case, if there are various user interfaces on the background, the layout of those user interfaces may be also changed. Specifically, as shown in FIG. 16, the position of start band (SB) may be changed from the first side 1021 to the third side 1023. Or, as shown in FIG. 17, if the background (WP) is touched, all objects displayed on the screen may be adjusted to the direction of user position.

Advantages of the present invention are not limited to advantages described herein, and other advantages not described herein may be understood clearly based on the present description and drawings accompanied to the same by persons having ordinary skill in the art to which the present invention pertains.

The above description is focused on a table-top display device of the present invention, but the present invention is not limited to the device. For example, the method for adjusting display orientation may be implemented by various electronic devices with a display function or a function detecting touches on displayed objects, including notebook computers, tablet computers, or smart phones.

Also, according to the description, a method for adjusting display orientation are performed by a table-top display device 1000, but methods for adjusting display orientation are not limited to the method performed by a table-top display device 1000. A method for adjusting display orientation may be performed by other devices performing functions identical or similar to the functions of described table-top display devices 1000.

On the other hand, as all of the above stages in a method for adjusting display orientation are not required, the method may be performed with some omitted stages. The described stages may be performed in orders different from the description, and some later stages may be performed in advance of some earlier stages.

As the above description is only to describe the spirit of the present invention for illustrative purposes, a person of ordinary skill in the art to which this invention pertains may implement various modifications, changes, and substitutions without departing from the essential characteristics of the present invention.

Therefore, the disclosed embodiments of the present invention are intended to describe, not to limit, the spirit of the present invention, and the same embodiments don't limit the scope of technical ideas of the present invention. The scope of protection of the present invention and all the technical ideas within the scope of its equivalent shall be construed by the following claims, and should be construed as being included in the scope of the present invention.

### Description of Code

1000: Table-top display device
1010: Table frame
1020: Display panel
A: Collaboration space
1100: Display module
1200: Touch sensitive module
1300: Controller
1400: Memory

What is claimed is:

1. A display device comprising:
a display;
a touch sensitive module detecting touches on the display; and
a controller configured to:
display, via the display, at least one object,
receive, via the touch sensitive module, a multi-touch on a specific object among the at least one object,
determine a user position based on positional relationship among touch points of the multi-touch, and
adjust display orientation of the specific object based on the user position.

2. The display device according to claim 1,
wherein the controller adjusts the display orientation by setting a direction from a upper side to a lower side of the specific object toward the user position.

3. The display device according to claim 1,
wherein the user position is a specific side on which a user is positioned among sides of the display, and
wherein the controller adjusts the display orientation by setting a direction from a upper side to a lower side of the specific object toward the specific side.

4. The display device according to claim 3,
wherein the direction is perpendicular to the specific side and the lower side is closer to the specific side than the upper side.

5. The display device according to claim 4,
wherein the upper side and the lower side of the specific object are parallel to the specific side.

6. The display device according to claim 3,
wherein the touch points of the multi-touch include first touch points and at least one second touch point, the first touch points including two farthest touch points among the touch points, and
wherein the specific side is farther from the at least one second touch point than each of the first touch points.

7. The display device according to claim 3,
wherein the touch points of the multi-touch include first touch points and at least one second touch point, the first touch points including two farthest touch points among the touch points, and
wherein the specific side is opposite to the at least one second touch point based on a line connecting the first touch points.

8. The display device according to claim 1,
wherein the touch points of the multi-touch include first touch points and at least one second touch point, the first touch points including two farthest touch points among the touch points, and
wherein the controller determines the user position based on a direction from the at least one second touch point to a line connecting the first touch points.

9. An electronic device comprising:
a display;
a touch sensitive module detecting touches on the display; and
a controller configure to:
display, via the display, at least one object,
receive, via the touch sensitive module, a multi-touch on a specific object among the at least one object, and
adjust display orientation of the specific object based on positional relationship among at least three touch points of the multi-touch.

10. The electronic device according to claim 9,
wherein a controller determines a specific side on which a user is positioned among sides of the display based on the positional relationship, and adjusts the display orientation in a normal direction to the specific side.

11. The electronic device according to claim 10,
wherein the normal direction to the specific side is a direction from a upper side to a lower side of the specific object is toward the specific side.

12. The electronic device according to claim 9,
wherein the at least three touch points include first touch points and at least one second touch point, the first touch points including two farthest touch points among the at least three touch points, and
wherein the controller adjusts the display orientation so that a direction from a upper side to a lower side of the specific object is toward a specific side of the display, the specific side being farther from the at least one second touch point than each of the first touch points.

13. The electronic device according to claim 9,
wherein the at least three touch points include first touch points and at least one second touch points, the first touch points including two farthest touch points among the at least three touch points, and
wherein the display orientation of a specific object is adjusted so that the direction from a upper side to a lower side of the specific object is toward a specific side of the display, the specific side being opposite to the at least one second touch point based on a line connecting the first touch points.

14. A method for adjusting display orientation comprising:
displaying at least one object;
receiving a multi-touch on a specific object among the at least one object;
determining a user position based on positional relationship among touch points of the multi-touch; and
adjusting the display orientation of the specific object based on the user position.

15. The method according to claim 14,
wherein the adjusting the display orientation includes setting a direction from a upper side to a lower side of the specific object toward the user position.

16. The method according to claim 14,
wherein the user position is a specific side on which a user is positioned among sides of the display, and
wherein the adjusting the display orientation includes setting the direction from a upper side to a lower side of the specific object toward the specific side.

17. The method according to claim 16,
wherein the touch points of the multi-touch include first touch points and at least one second touch point, the first touch points including two farthest touch points among the touch points,
wherein the specific side is farther from the at least one second touch point than each of the first touch points.

18. The method according to claim 16,
wherein the touch points of the multi-touch include first touch points and at least one second touch point, the first touch points including two farthest touch points among the touch points,
wherein the specific side is opposite to the at least one second touch point based on a line connecting the first touch points.

19. The method according to claim 14,
wherein the touch points of the multi-touch include first touch points and at least one second touch point, the first touch points including two farthest touch points among the touch points,
wherein the user position is determined based on a direction from the at least one second touch point to a line connecting the first touch points.
